(19) United States
(12) Patent Application Publication
(10) Pub. No.: US 2025/0303550 A1
(43) Pub. Date: Oct. 2, 2025

(54) ROBOT AND ROBOT SYSTEM

(71) Applicant: SEIKO EPSON CORPORATION, Tokyo (JP)

(72) Inventors: Daisuke YAMAZAKI, SAKAKI-MACHI (JP); Yuji KAJIHARA, AZUMINO-SHI (JP)

(21) Appl. No.: 19/093,971

(22) Filed: Mar. 28, 2025

(30) Foreign Application Priority Data
Mar. 28, 2024 (JP) 2024-055120

(51) Int. Cl. B25J 9/00; B25J 9/16; B25J 19/00

(52) U.S. Cl. CPC B25J 9/0009; B25J 9/1615; B25J 19/0025

(57) ABSTRACT

A robot includes a base, a first arm that rotates around a first rotation axis with respect to the base, a second arm that rotates around a second rotation axis with respect to the first arm, a shaft that linearly moves along a third rotation axis with respect to the second arm and that rotates around the third rotation axis, a first motor that linearly moves the shaft along the third rotation axis, a second motor that rotates the shaft around the third rotation axis, a duct that couples the base and the second arm and that includes a proximal end opening which faces an inside of the base and a distal end opening which faces an inside of the second arm, and a wiring holding member that holds wiring drawn into the second arm from the duct.

### CROSS-REFERENCE TO RELATED APPLICATIONS

The present application is based on, and claims priority from JP Application Serial Number 2024-055120, filed Mar. 28, 2024, the disclosure of which is hereby incorporated by reference herein in its entirety.

### BACKGROUND OF THE INVENTION

### 1. Technical Field

The present disclosure relates to a robot and a robot system.

### 2. Related Art

A SCARA robot (horizontal articulated robot) described in JP-A-2019-209384 has a base, a first arm that is rotatably joined around a first rotation axis along a vertical direction with respect to the base, a second arm that is rotatably joined around a second rotation axis along the vertical direction with respect to the first arm, and a work head that is disposed at the second arm. In addition, the work head has a shaft that can be linearly moved (raised and lowered) along a third rotation axis, which follows the vertical direction, with respect to the second arm and that is rotatable around the third rotation axis. In addition, in the second arm, a motor for rotating the second arm around the second rotation axis with respect to the first arm, a motor for linearly moving the shaft along the third rotation axis with respect to the second arm, and a motor for rotating the shaft around the third rotation axis with respect to the second arm are disposed. In addition, the SCARA robot has a pipe member (conduit tube) that links the base and the second arm, and a signal line for each motor is drawn into the second arm from the base through an inside of the pipe member.

In such a SCARA robot, the signal line for each motor, which is drawn into the second arm via the pipe member, is drawn to pass above the motor. For this reason, a space for drawing the signal line above each motor is necessary, and it is difficult to reduce the second arm in height.

### SUMMARY OF THE INVENTION

According to an aspect of the present disclosure, there is provided a robot including:
a base;
a first arm that is joined to the base and that rotates around a first rotation axis with respect to the base;
a second arm that is joined to the first arm at a proximal end portion and that rotates around a second rotation axis, which is parallel to the first rotation axis, with respect to the first arm;
a shaft that is disposed at a distal end portion of the second arm, that linearly moves along a third rotation axis, which is parallel to the first rotation axis, with respect to the second arm, and that rotates around the third rotation axis;
a first motor that is disposed in the second arm and that linearly moves the shaft along the third rotation axis with respect to the second arm;
a second motor that is disposed in the second arm and that rotates the shaft around the third rotation axis with respect to the second arm;
a duct that couples the base and the second arm and that includes a proximal end opening which faces an inside of the base and a distal end opening which faces an inside of the second arm;
wiring that is drawn into the second arm from the inside of the base through an inside of the duct; and
a wiring holding member that is disposed in the second arm and that includes a holding portion which holds the wiring drawn into the second arm from the duct, in which
the second arm includes an arm base that is joined to the first arm and that holds the first motor and the second motor and a frame that is fixed to the arm base and that includes a coupling portion to which the duct is coupled, and
when a line segment that is orthogonal to the second rotation axis and that passes through the second rotation axis and the third rotation axis is defined as an imaginary central axis of the second arm,
   the first motor and the second motor are arranged in parallel along a direction intersecting the imaginary central axis in plan view from a direction along the second rotation axis,
   the distal end opening of the duct is positioned closer to a proximal end side of the second arm than the first motor and the second motor are,
   in plan view from a direction along the imaginary central axis, the holding portion is positioned between the first motor and the second motor, and
   the wiring passes between the first motor and the second motor and is drawn to a distal end side of the second arm.

According to another aspect of the present disclosure, there is provided a robot system including:
a robot; and
a control device that controls driving of the robot, in which
the robot includes
   a base,
   a first arm that is joined to the base and that rotates around a first rotation axis with respect to the base,
   a second arm that is joined to the first arm at a proximal end portion and that rotates around a second rotation axis, which is parallel to the first rotation axis, with respect to the first arm,
   a shaft that is disposed at a distal end portion of the second arm, that linearly moves along a third rotation axis, which is parallel to the first rotation axis, with respect to the second arm, and that rotates around the third rotation axis,
   a first motor that is disposed in the second arm and that linearly moves the shaft along the third rotation axis with respect to the second arm,
   a second motor that is disposed in the second arm and that rotates the shaft around the third rotation axis with respect to the second arm,
   a duct that couples the base and the second arm and that includes a proximal end opening which faces an inside of the base and a distal end opening which faces an inside of the second arm,
   wiring that is drawn into the second arm from the inside of the base through an inside of the duct, and
   a wiring holding member that is disposed in the second arm and that includes a holding portion which holds the wiring drawn into the second arm from the duct,
the second arm includes an arm base that is joined to the first arm and that holds the first motor and the second motor and a frame that is fixed to the arm base and that includes a coupling portion to which the duct is coupled, and
when a line segment that is orthogonal to the second rotation axis and that passes through the second rotation axis and the third rotation axis is defined as an imaginary central axis of the second arm,
   the first motor and the second motor are arranged in parallel along a direction intersecting the imaginary central axis in plan view from a direction along the second rotation axis,
   the distal end opening of the duct is positioned closer to a proximal end side of the second arm than the first motor and the second motor are,
   in plan view from a direction along the imaginary central axis, the holding portion is positioned between the first motor and the second motor, and
   the wiring passes between the first motor and the second motor and is drawn to a distal end side of the second arm.

### BRIEF DESCRIPTION OF DRAWINGS

FIG. 1 is a side view illustrating a robot according to a preferred embodiment.

FIG. 2 is a cross-sectional view illustrating a joined portion between a base and a first arm.

FIG. 3 is a cross-sectional view of a second arm viewed from one side in a horizontal direction.

FIG. 4 is a cross-sectional view of the second arm viewed from the other side in the horizontal direction.

FIG. 5 is a top view illustrating an inside of the second arm.

FIG. 6 is a perspective view illustrating a distal end portion of a frame.

FIG. 7 is a cross-sectional view illustrating the distal end portion of the frame.

FIG. 8 is a plan view of a duct viewed along an imaginary central axis from a distal end side of the second arm.

FIG. 9 is a perspective view of a wiring holding member.

FIG. 10 is a perspective view illustrating a state where the wiring holding member holds wiring and a pipe.

FIG. 11 is an enlarged cross-sectional view illustrating a vicinity of a distal end opening of the duct.

FIG. 12 is a plan view illustrating overlapping of the distal end opening of the duct and the wiring holding member.

FIG. 13 is a cross-sectional view illustrating a modification example of the wiring holding member.

### DETAILED DESCRIPTION OF THE INVENTION

Hereinafter, a robot and a robot system of the present disclosure will be described in detail based on an embodiment illustrated in the accompanying drawings.

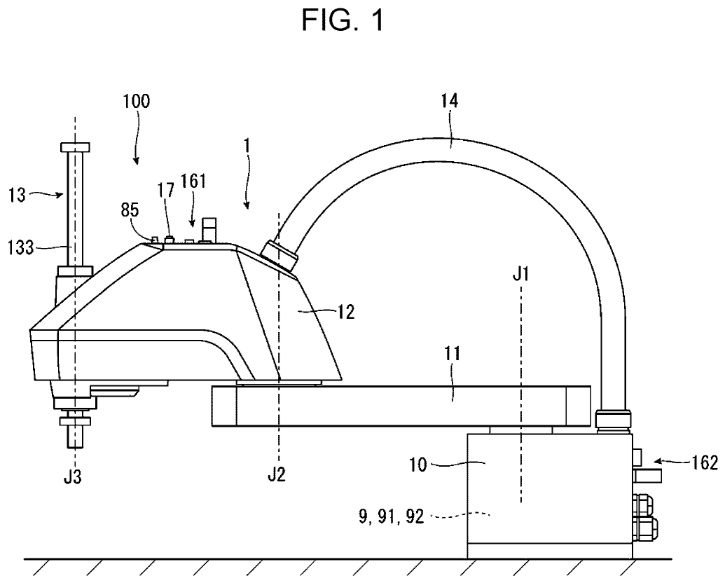

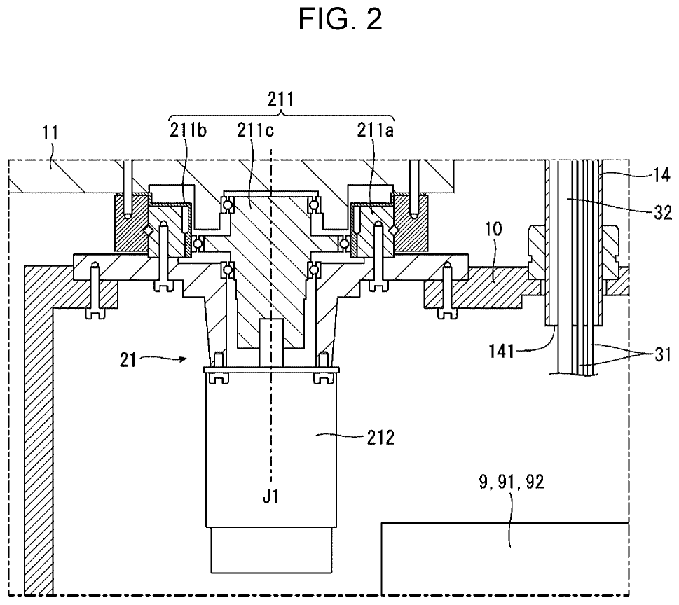

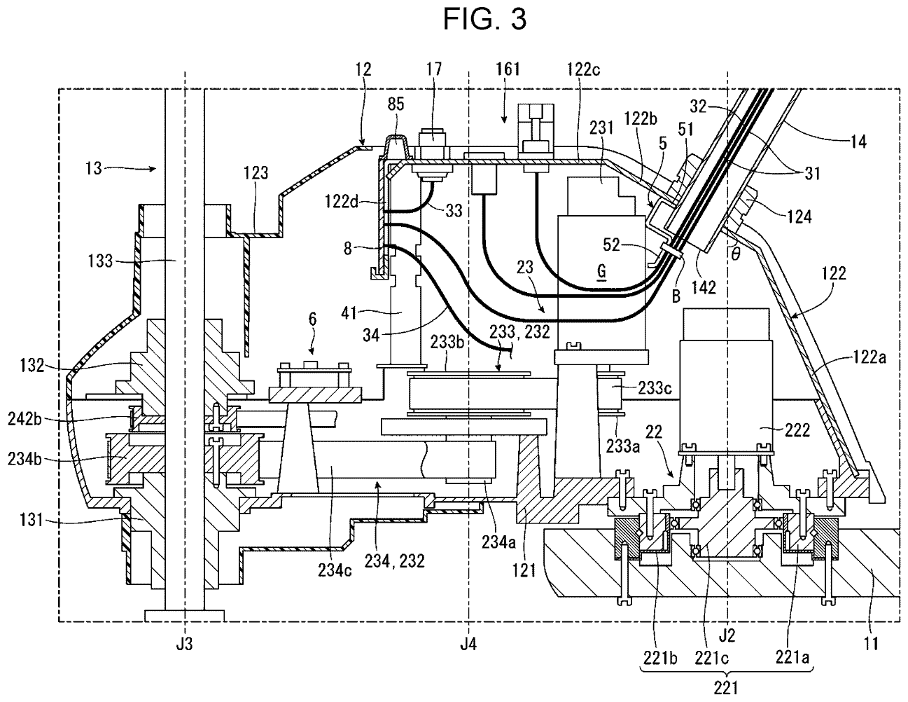

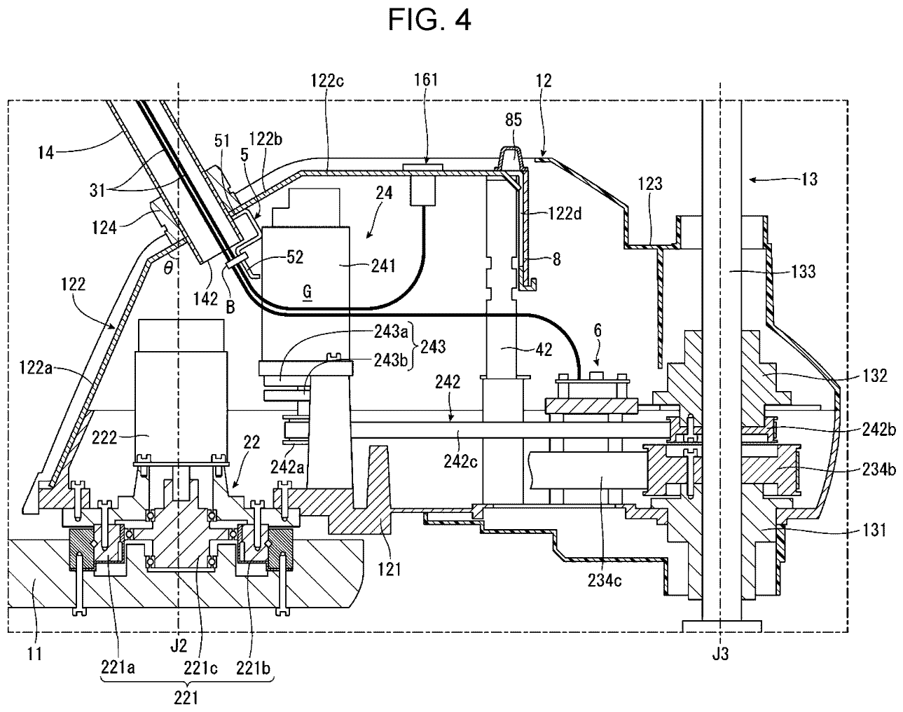

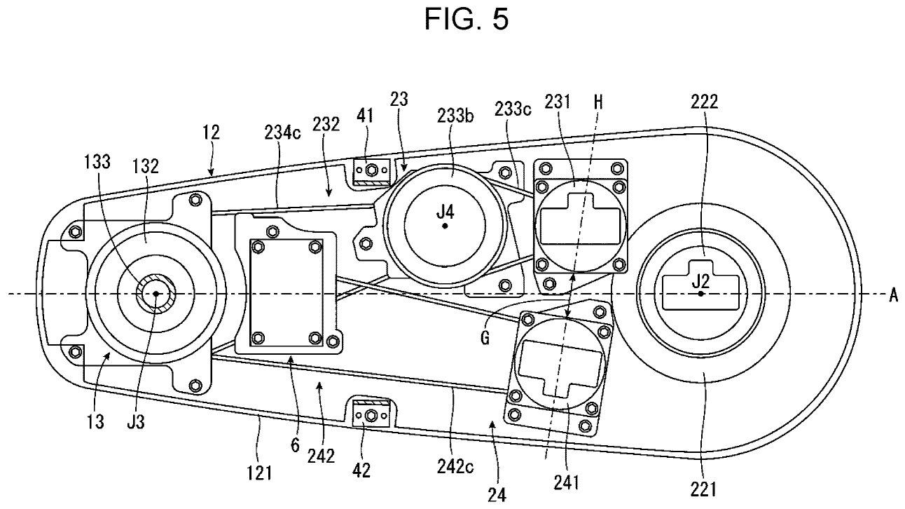

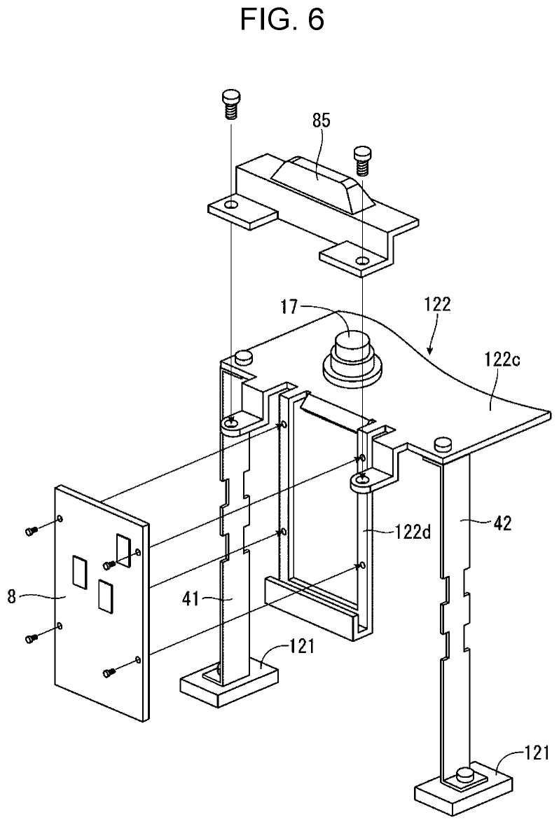

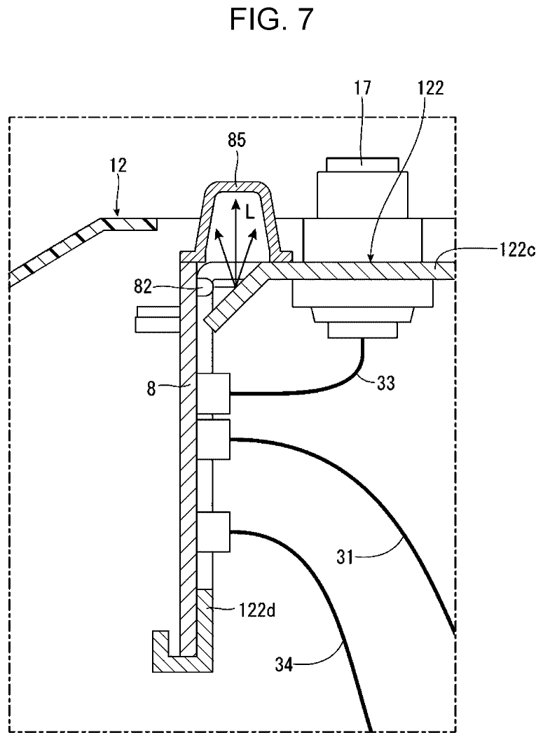

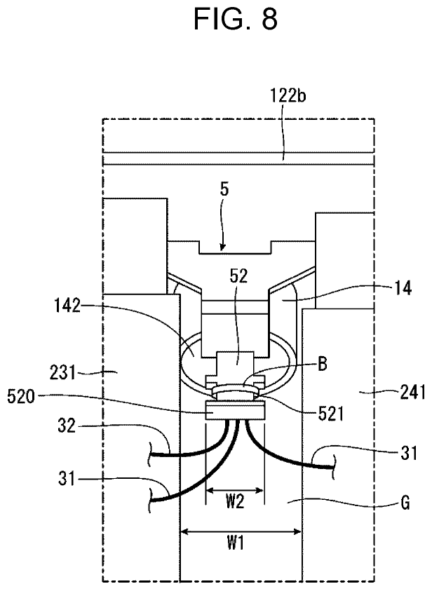

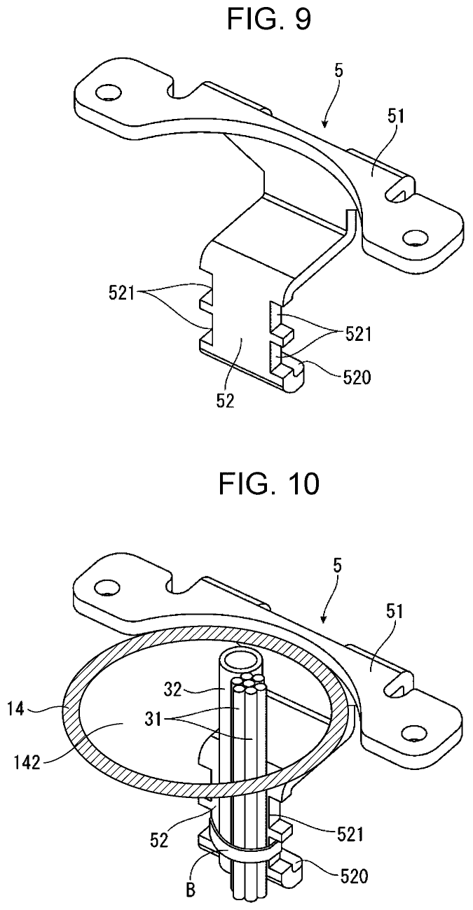

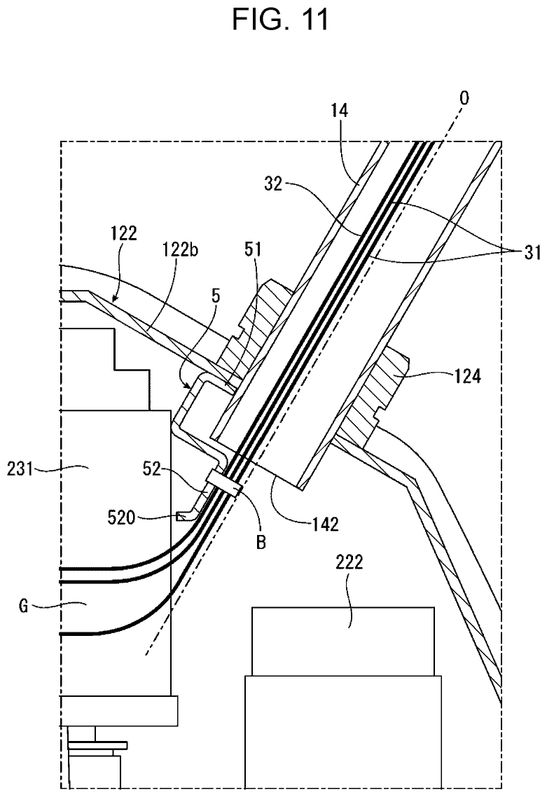

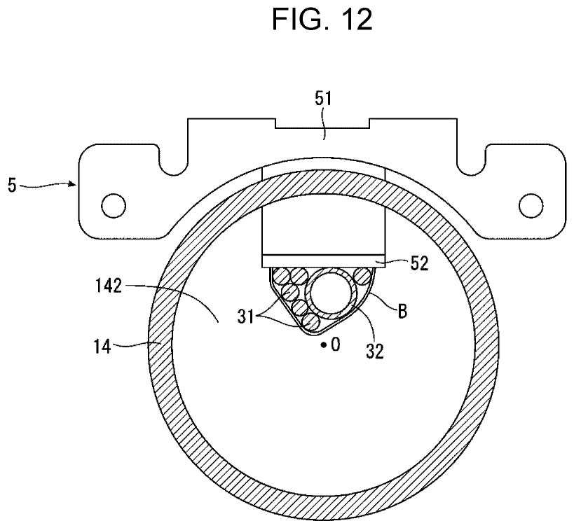

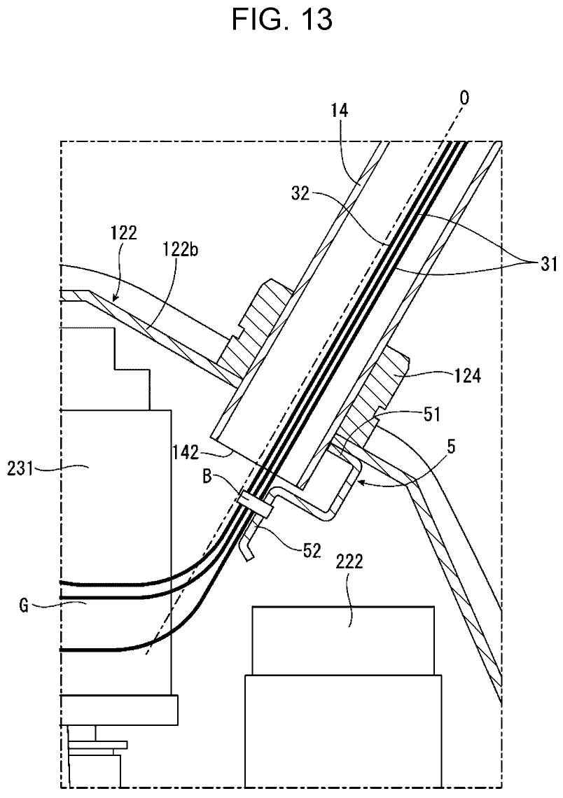

FIG. 1 is a side view illustrating a robot according to a preferred embodiment. FIG. 2 is a cross-sectional view illustrating a joined portion between a base and a first arm. FIG. 3 is a cross-sectional view of a second arm viewed from one side in a horizontal direction. FIG. 4 is a cross-sectional view of the second arm viewed from the other side in the horizontal direction. FIG. 5 is a top view illustrating an inside of the second arm. FIG. 6 is a perspective view illustrating a distal end portion of a frame. FIG. 7 is a cross-sectional view illustrating the distal end portion of the frame. FIG. 8 is a plan view of a duct viewed along an imaginary central axis from a distal end side of the second arm. FIG. 9 is a perspective view of a wiring holding member. FIG. 10 is a perspective view illustrating a state where the wiring holding member holds wiring and a pipe. FIG. 11 is an enlarged cross-sectional view illustrating a vicinity of a distal end opening of the duct. FIG. 12 is a plan view illustrating overlapping of the distal end opening of the duct and the wiring holding member. FIG. 13 is a cross-sectional view illustrating a modification example of the wiring holding member.

An up/down direction in FIG. 1 matches a vertical direction. For this reason, hereinafter, an upper side in FIG. 1 will also be referred to as “up”, and a lower side will also be referred to as “down”. In addition, in the present specification, the term “vertical” means not only including a case of matching the vertical, but also including a case of being inclined with respect to the vertical within a range in which an effect of the present disclosure can be exhibited, for example, a case of being inclined within ±5° with respect to the vertical. Similarly, in the present specification, the term “parallel” means not only including a case where two objects are parallel to each other, but also a case where the two objects are inclined from the parallel within a range in which the effect of the present disclosure can be exhibited, for example, a case where the two objects are inclined within ±5° with respect to the parallel.

A robot system 100 illustrated in FIG. 1 has a robot 1 and a control device 9 that controls driving of the robot 1.

### Control Device 9

As illustrated in FIG. 1, the control device 9 has, for example, a control substrate 91 and a power supply substrate 92. However, without being limited thereto, the control substrate 91 and the power supply substrate 92 may be one substrate.

The control substrate 91 collectively controls the driving of each portion of the robot 1. The control substrate 91 includes a central processing unit (CPU), a random access memory (RAM), and a read only memory (ROM). The functions described above are achieved as the CPU reads and executes a program stored in the ROM. The control substrate 91 is electrically coupled to a host computer (not illustrated) and controls the driving of each portion of the robot 1 based on a command from the host computer. However, without being limited thereto, a circuit and the like of the control substrate 91 may be divided into a plurality of substrates.

The power supply substrate 92 supplies power to the control substrate 91. The power supply substrate 92 includes a conversion circuit that converts power supplied from the outside into a predetermined value to supply the power to the control substrate 91. The conversion circuit varies depending on the configuration of the robot 1, but examples thereof include an AC/DC conversion circuit that converts an alternating current (AC) to a direct current (DC) and a booster circuit or a step-down circuit that converts a voltage level of a signal. However, without being limited thereto, a circuit and the like of the power supply substrate 92 may be divided into a plurality of substrates.

However, the configuration of the control device 9 is not particularly limited insofar as the driving of the robot 1 can be controlled. In addition, the control device 9 is disposed in a base 10 of the robot 1 in the present embodiment, but the disposition of the control device 9 is not particularly limited. For example, the control device 9 may be installed outside the base 10. In this case, the robot 1 and the control device 9 may be coupled by a cable or may be wirelessly coupled.

### Robot 1

The robot 1 is a horizontal articulated robot (SCARA robot). As illustrated in FIG. 1, the robot 1 has the base 10 fixed to a floor or the like, a first arm 11 rotatably joined to the base 10, a second arm 12 rotatably joined to the first arm 11, a work head 13 disposed at the second arm 12, and a duct 14 that couples the base 10 and the second arm 12.

As illustrated in FIG. 2, the first arm 11 is joined to the base 10 at a proximal end portion thereof and rotates around a first rotation axis J1 along the vertical direction with respect to the base 10.

As illustrated in FIGS. 3 and 4, the second arm 12 is joined to the first arm 11 at a proximal end portion thereof and rotates around a second rotation axis J2, which is parallel to the first rotation axis J1, with respect to the first arm 11. In addition, the second arm 12 includes a hard arm base 121 joined to the first arm 11, a frame 122 fixed to the arm base 121, and a cover 123 covering the arm base 121 from above the frame 122. For example, the arm base 121 and the frame 122 are made of a lightweight and hard metal material such as aluminum, and the cover 123 is made of a lightweight resin material.

In addition, the second arm 12 includes an inertia sensor module 6 that measures inertia of the second arm 12. The inertia sensor module 6 is disposed on a distal end side of the second arm 12 with respect to a brake control substrate 8 and detects at least one of an angular speed and acceleration of the second arm 12. The inertia sensor module 6 is disposed at a position overlapping an imaginary central axis A to be described later in plan view from a direction along the second rotation axis J2. However, without being limited thereto, the inertia sensor module 6 may be disposed at a position that does not overlap the imaginary central axis A.

As illustrated in FIG. 1, the duct 14 is a tubular member disposed outside the first arm 11 and directly couples the base 10 and the second arm 12 without passing through the first arm 11. In addition, as illustrated in FIGS. 2 and 3, the duct 14 has a proximal end portion coupled to the base 10, has a distal end portion coupled to the second arm 12, and has a proximal end opening 141 that faces an inside of the base 10 and a distal end opening 142 that faces an inside of the second arm 12. Accordingly, a space in the base 10 and a space in the second arm 12 communicate with each other via the duct 14.

In the robot 1, a plurality of pieces of signal wiring 31 and a pressure air pipe 32 are drawn from the base 10 into the second arm 12 via the duct 14. With such a configuration, since the wiring 31 and the pipe 32 can be drawn from the base 10 to the second arm 12 without passing through the first arm 11, the wiring 31 and the pipe 32 can be easily drawn. At least one piece of wiring 31 may be inserted through the duct 14, and the pipe 32 may be omitted. In addition, a pipe other than the wiring 31 and the pipe 32, for example, a pipe for liquid to be sent may be inserted.

As illustrated in FIGS. 3 and 4, the work head 13 is disposed at a distal end portion of the second arm 12. In addition, the work head 13 has a spline nut 131 and a ball screw nut 132 that are coaxially disposed in the vertical direction and a spline shaft 133 that is a shaft inserted through the spline nut 131 and the ball screw nut 132. In such a work head 13, when the spline nut 131 is rotated, the spline shaft 133 rotates around a central axis thereof, which is the third rotation axis J3 parallel to the first rotation axis J1, and moves linearly (up and down) along the third rotation axis J3. When the ball screw nut 132 is rotated, the spline shaft 133 moves linearly along the third rotation axis J3. When both the spline nut 131 and the ball screw nut 132 are rotated, the spline shaft 133 rotates around the third rotation axis J3. Although not illustrated, an end effector according to work is mounted on a lower end portion of the spline shaft 133.

In addition, as illustrated in FIGS. 2 and 3, the robot 1 has a first arm drive mechanism 21 that rotates the first arm 11 around the first rotation axis J1 with respect to the base 10 and a second arm drive mechanism 22 that rotates the second arm 12 around the second rotation axis J2 with respect to the first arm 11.

As illustrated in FIG. 2, the first arm drive mechanism 21 has a decelerator 211 that rotatably joins the base 10 and the first arm 11 and an encoder built-in motor 212 disposed in the base 10.

The motor 212 is a servo motor, particularly a three-phase motor driven by a three-phase alternating current, and is fixed to the base 10.

The decelerator 211 is a wave gear device, a circular spline 211a is fixed to the base 10, and a flex spline 211b is fixed to the first arm 11. In addition, a rotation shaft of the motor 212 is fixed to a wave generator 211c. For this reason, the wave generator 211c rotates together with the rotation of the motor 212, and further, the flex spline 211b rotates with a predetermined deceleration ratio with respect to the rotation of the wave generator 211c. As a result, the first arm 11 rotates around the first rotation axis J1 with respect to the base 10. However, the configuration of the first arm drive mechanism 21 is not particularly limited.

The second arm drive mechanism 22 has the same configuration as that of the first arm drive mechanism 21. As illustrated in FIGS. 3 and 4, the second arm drive mechanism 22 has a decelerator 221 that rotatably joins the first arm 11 and the second arm 12 and an encoder built-in motor 222 disposed in the second arm 12.

The motor 222 is a servo motor, particularly a three-phase motor driven by a three-phase alternating current, and is fixed to the arm base 121.

The decelerator 221 is a wave gear device, a circular spline 221a is fixed to the arm base 121, and a flex spline 221b is fixed to the first arm 11. In addition, a rotation shaft of the motor 222 is fixed to a wave generator 221c. For this reason, the wave generator 221c rotates together with the rotation of the motor 222, and further, the flex spline 221b rotates with a predetermined deceleration ratio with respect to the rotation of the wave generator 221c. As a result, the second arm 12 rotates around the second rotation axis J2 with respect to the first arm 11. However, the configuration of the second arm drive mechanism 22 is not particularly limited.

In addition, as illustrated in FIGS. 3 to 5, the robot 1 has a spline shaft first drive mechanism 23 that rotates the spline nut 131 to rotate and linearly move the spline shaft 133 and a spline shaft second drive mechanism 24 that rotates the ball screw nut 132 to linearly move the spline shaft 133.

As illustrated in FIGS. 3 and 5, the spline shaft first drive mechanism 23 has an encoder built-in motor 231 that is a second motor disposed in the second arm 12 and a deceleration mechanism 232 that transmits rotation of the motor 231 to the spline nut 131.

The motor 231 is a servo motor, particularly a three-phase motor driven by a three-phase alternating current, and is fixed to the arm base 121.

The deceleration mechanism 232 has a first deceleration mechanism 233 and a second deceleration mechanism 234. The first deceleration mechanism 233 has a pulley 233a attached to a rotation shaft of the motor 231, a first intermediate pulley 233b rotatably supported around a fourth rotation axis J4, which is parallel to the second rotation axis J2, with respect to the arm base 121, and a belt 233c wound around the pulley 233a and the first intermediate pulley 233b. The first intermediate pulley 233b has a diameter larger than that of the pulley 233a. The second deceleration mechanism 234 has a second intermediate pulley 234a that is coaxially disposed with the first intermediate pulley 233b and that rotates around the fourth rotation axis J4 together with the first intermediate pulley 233b, a pulley 234b that is a first pulley fixed to the spline nut 131, and a belt 234c that is a first belt wound around the second intermediate pulley 234a and the pulley 234b. The second intermediate pulley 234a has a diameter smaller than that of the first intermediate pulley 233b, and the pulley 234b has a diameter larger than that of the second intermediate pulley 234a.

In such a configuration, rotation of the motor 231 is transmitted to the first intermediate pulley 233b via the pulley 233a and the belt 233c, and the first intermediate pulley 233b and the second intermediate pulley 234a rotate integrally around the fourth rotation axis J4. In addition, rotation of the second intermediate pulley 234a is transmitted to the pulley 234b via the belt 234c, and the pulley 234b and the spline nut 131 integrally rotate around the third rotation axis J3. Accordingly, the spline shaft 133 rotates and moves linearly. As described above, by using the deceleration mechanism 232 that includes the first deceleration mechanism 233 and the second deceleration mechanism 234, the rotation of the motor 231 can be decelerated in two stages, and the spline nut 131 can be rotated with larger torque. However, the configuration of the spline shaft first drive mechanism 23 is not particularly limited.

As illustrated in FIG. 4, the spline shaft second drive mechanism 24 has an encoder built-in motor 241 that is a first motor disposed in the second arm 12, a deceleration mechanism 242 that transmits rotation of the motor 241 to the ball screw nut 132, and a brake 243 for the motor 241.

The motor 241 is a servo motor, particularly a three-phase motor driven by a three-phase alternating current and is fixed to the arm base 121.

The deceleration mechanism 242 has a pulley 242a attached to a rotation shaft of the motor 241, a pulley 242b that is a second pulley attached to the ball screw nut 132, and a belt 242c that is a second belt wound around the pulleys 242a and 242b. In such a configuration, rotation of the motor 241 is transmitted to the pulley 242b via the pulley 242a and the belt 242c, and the pulley 242b and the ball screw nut 132 integrally rotate around the third rotation axis J3. Accordingly, the spline shaft 133 linearly moves. As described above, the rotation of the motor 241 can be decelerated by using the deceleration mechanism 242, and the ball screw nut 132 can be rotated with sufficiently large torque. However, the configuration of the spline shaft second drive mechanism 24 is not particularly limited.

The brake 243 is an electromagnetic brake and has a pair of plates 243a and 243b disposed to face each other. In addition, one plate 243a is fixed to the motor 241, and the other plate 243b is fixed to the rotation shaft of the motor 241 and rotates together with the rotation shaft. Then, through ON/OFF control of power supply, a brake state where the plates 243a and 243b are brought into contact with each other to restrict the rotation of the rotation shaft and a brake release state where the plates 243a and 243b are separated from each other to allow the rotation of the rotation shaft are switched. In particular, the brake 243 of the present embodiment is an unexcited operation type electromagnetic brake, is in the brake release state when power is supplied (ON), and is in the brake state when power is cut off (OFF). However, the configuration of the brake 243 is not particularly limited.

Main portions of the robot 1 are briefly described hereinbefore. Next, the second arm 12 will be described in more detail.

As described above, the second arm 12 has the hard arm base 121 joined to the first arm 11, the frame 122 fixed to the arm base 121, and the cover 123 covering the arm base 121 from above the frame 122.

As illustrated in FIGS. 3 and 4, the frame 122 is formed by, for example, performing molding on a sheet metal. In addition, the frame 122 protrudes obliquely upward from a proximal end portion of the arm base 121 toward the distal end side of the second arm 12. In addition, the frame 122 is a cantilever beam and has a proximal end portion which is a fixed end fixed to the arm base 121 and a distal end portion which is a free end.

Such a frame 122 generally has a shape in which a strip-like sheet metal is bent on the same side at three places in the middle and has a configuration where a first portion 122a, a second portion 122b, a third portion 122c, and a fourth portion 122d, of which directions of plate surfaces are different from each other, are arranged from a proximal end side.

In addition, an inclination angle θ with respect to the second rotation axis J2 is gradually increased from the first portion 122a toward the third portion 122c. That is, the inclination angle θ of the first portion 122a<the inclination angle θ of the second portion 122b<the inclination angle θ of the third portion 122c is satisfied. In particular, in the present embodiment, the inclination angle θ of the first portion 122a is 30°, the inclination angle θ of the second portion 122b is 60°, and the inclination angle θ of the third portion 122c is 90°. That is, the third portion 122c is orthogonal to the second rotation axis J2, and the plate surface faces the vertical direction. On the other hand, the fourth portion 122d is bent perpendicularly downward with respect to the third portion 122c, and the inclination angle θ with respect to the second rotation axis J2 is 0°. That is, the fourth portion 122d is parallel to the second rotation axis J2, and the plate surface faces a horizontal direction (an extending direction of the second arm 12).

The first portion 122a is fixed to the arm base 121. In addition, a coupling portion 124 to which the duct 14 is coupled is disposed at the second portion 122b. The duct 14 is fixed to the coupling portion 124 in a state where the distal end portion thereof is inserted through the coupling portion 124. In addition, the coupling portion 124 is positioned above the second rotation axis J2 and intersects the second rotation axis J2. For this reason, deformation of the duct 14 when the second arm 12 rotates around the second rotation axis J2 can be suppressed, and stress applied to the duct 14 and the wiring 31 and the pipe 32 passing through the duct 14 can be reduced. However, the position of the coupling portion 124 is not particularly limited and may not overlap the second rotation axis J2.

In addition, a connector group 161 including a connector for the wiring 31 and a connector for the pipe 32 and a brake release button 17 for releasing the brake 243 are disposed at the third portion 122c. The connector group 161 and the brake release button 17 are exposed to the outside of the second arm 12 without being covered with the cover 123. For this reason, a user easily accesses the connector group 161 and the brake release button 17. As illustrated in FIG. 1, a connector group 162 including a plurality of connectors that form a pair with each of the connectors included in the connector group 161 is disposed on a back surface of the base 10, and the connectors that form a pair are coupled to each other via the wiring 31 or the pipe 32.

In addition, a lens 85 that is illuminated by light L incident from a light emitting element 82 to be described later is disposed at the third portion 122c. In addition, the lens 85 is exposed to the outside of the second arm 12 without being covered with the cover 123.

In addition, as illustrated in FIG. 6, the distal end portion of the frame 122 is supported by the arm base 121 via a pair of support members 41 and 42. As described above, since the frame 122 is a cantilever beam, a distal end side is easily bent up and down. For this reason, for example, there is a concern that the frame 122 is plastically deformed by stress applied when the user inserts a connector into the connector group 161, when the brake release button 17 is pressed, or when wiring or a device coupled to the connector group 161 is installed on the frame 122. Thus, by supporting the distal end portion of the frame 122 with the pair of support members 41 and 42, the deformation of the frame 122 can be effectively suppressed. In particular, by supporting the third portion 122c at which the connector group 161 and the brake release button 17 are disposed with the support members 41 and 42, the effect described above becomes more remarkable.

In addition, as illustrated in FIGS. 6 and 7, the brake control substrate 8 that controls the brake 243 is fixed to the fourth portion 122d. As illustrated in FIGS. 3 and 4, the brake control substrate 8 is electrically coupled to the control substrate 91 via the wiring 31. In addition, the brake control substrate 8 is electrically coupled to the brake 243 via wiring 34 and is electrically coupled to the brake release button 17 via the wiring 33. Such a brake control substrate 8 controls driving of the brake 243 based on a command from the control substrate 91 and switches between the brake state/brake release states. In addition, the brake control substrate 8 controls the driving of the brake 243 based on the operation of the brake release button 17 and switches between the brake state/brake release state.

In addition, as illustrated in FIG. 7, the robot 1 has the light emitting element 82 mounted on the brake control substrate 8. The light emitting element 82 is, for example, a light emitting diode (LED). The light L emitted from the light emitting element 82 is diffusely reflected upward by the frame 122 and then is incident to the lens 85. Accordingly, the lens 85 is illuminated. For this reason, by controlling driving of the light emitting element 82 to switch the lighting/blinking/extinguishing of the lens 85 or to switch a light emission color of the lens 85, the user can be notified of various types of information via the lens 85.

The brake control substrate 8 causes the light emitting element 82 to emit the light L of a predetermined color and illuminates the lens 85 while power is supplied to the motors 212, 222, 231, and 241, that is, while the power of the robot 1 is turned on. Hereinafter, this state is also referred to as a first light emission state. Accordingly, the user can be easily notified that the power of the robot 1 is turned on. In addition, when the brake release button 17 is pressed and the brake 243 is brought into the brake release state, the brake control substrate 8 causes the light emitting element 82 to emit the light L of a color different from the first light emission state and illuminates the lens 85. Hereinafter, this state is also referred to as a second light emission state. Accordingly, the user can be easily notified that the brake 243 is in the brake release state. In addition, by switching between the first light emission state and the second light emission state, the user can be more clearly notified of the state of the robot 1.

The brake control substrate 8 described above includes a central processing unit (CPU), a read only memory (ROM), and the like. The functions described above are achieved as the CPU reads and executes a program and data stored in the ROM.

In addition, as illustrated in FIG. 5, when an imaginary line segment orthogonal to the second rotation axis J2 and passing through the second rotation axis J2 and the third rotation axis J3 is defined as the imaginary central axis A of the second arm 12, the motors 231 and 241 are arranged in parallel with a gap G along a direction H intersecting the imaginary central axis A in plan view from the direction along the second rotation axis J2. In particular, in the present embodiment, the motor 231 is positioned on one side with respect to the imaginary central axis A, and the motor 241 is positioned on the other side. For this reason, the motors 231 and 241 can be disposed in the second arm 12 in a balanced manner, and twisting or the like around the imaginary central axis A caused by a bias of the weight of the second arm 12 can be suppressed. In the illustrated configuration, the motor 231 is positioned closer to the proximal end side of the second arm 12 than the motor 241 is, and the direction H is inclined with respect to a perpendicular line of the imaginary central axis A. However, without being limited thereto, the motors 231 and 241 may be arranged side by side horizontally, and the direction H may be orthogonal to the imaginary central axis A, or the motor 231 may be positioned closer to the distal end side of the second arm 12 than the motor 241 is, and the direction H may be inclined to an opposite side of the perpendicular line of the imaginary central axis A of the present embodiment.

In addition, as illustrated in FIG. 8, in plan view from a direction along the imaginary central axis A, an upper end of the motor 231 is positioned above an upper end of the motor 241. However, without being limited thereto, the upper end of the motor 231 and the upper end of the motor 241 may have the same height, or the upper end of the motor 231 may be positioned below the upper end of the motor 241.

In addition, as illustrated in FIGS. 3 and 4, the gap G between the motors 231 and 241 is positioned closer to the distal end side of the second arm 12 than the distal end opening 142 of the duct 14 is. In addition, the motors 231 and 241 are positioned closer to the proximal end side of the second arm 12 than the connector group 161 is. That is, the motors 231 and 241 are positioned between the distal end opening 142 and the connector group 161.

In addition, as illustrated in FIGS. 3 and 4, the robot 1 has a wiring holding member 5 disposed in the second arm 12. The wiring holding member 5 has a shape illustrated in FIG. 9 and is formed by performing molding on a sheet metal. The wiring holding member 5 is a member that holds the wiring 31 and the pipe 32 drawn into the second arm 12 from the distal end opening 142 of the duct 14 and has a fixing portion 51 fixed to the second portion 122b of the frame 122 and a holding portion 52 that extends from the fixing portion 51 and that holds the wiring 31 and the pipe 32.

As described above, by fixing the fixing portion 51 to the frame 122, the holding portion 52 is easily disposed close to the distal end opening 142. For this reason, the wiring 31 and the pipe 32 are easily held. In addition, since portions of the wiring 31 and the pipe 32 immediately after being drawn from the distal end opening 142 can be held, oscillation of the wiring 31 and the pipe 32 in the second arm 12 can be effectively suppressed. In particular, in the present embodiment, since the fixing portion 51 is fixed to the same second portion 122b as the coupling portion 124, the effect described above becomes more remarkable.

In the present embodiment, as illustrated in FIG. 10, the wiring 31 and the pipe 32 are bundled and tied to the holding portion 52 using a binding band B. Accordingly, the wiring 31 and the pipe 32 can be easily held by the holding portion 52. However, the method of holding the wiring 31 and the pipe 32 is not particularly limited, and for example, the wiring 31 and the pipe 32 may be tied to the holding portion 52 with a string, or the wiring 31 and the pipe 32 may be directly wound around or bound to the holding portion 52. In addition, all the wiring 31 and the pipe 32 drawn from the distal end opening 142 are held by the holding portion 52 in the present embodiment, but without being limited thereto, specific wiring 31 or a specific pipe 32 may not be held by the holding portion 52. Examples of the “specific wiring 31” include the wiring 31 in which when a coupling destination is positioned close to the distal end opening 142 and is held by the holding portion 52, the coupling becomes rather difficult or stress caused by the curvature increases.

In addition, the holding portion 52 has a plate shape having a thickness in the direction along the imaginary central axis A and having a width in a perpendicular line direction of the imaginary central axis A in plan view from the direction along the second rotation axis J2, and as illustrated in FIG. 9, a plurality of grooves 521 are formed along an extending direction of the holding portion 52 on both sides in a width direction thereof. For this reason, as illustrated in FIG. 10, slipping-out of the binding band B can be effectively suppressed by hooking the binding band B on any of the grooves 521. For this reason, the wiring 31 and the pipe 32 can be more reliably held by the holding portion 52.

In addition, as illustrated in FIGS. 9 and 10, a distal end portion 520 of the holding portion 52 is bent to the distal end side of the second arm 12. For this reason, an edge of a distal end surface of the holding portion 52 is less likely to come into contact with the wiring 31 and the pipe 32, and damage to the wiring 31 and the pipe 32 can be effectively suppressed.

In addition, as illustrated in FIG. 11, the holding portion 52 is disposed along a central axis O of the duct 14. Specifically, the central axis O of the distal end portion (a portion held by the coupling portion 124) of the duct 14 is orthogonal to the second portion 122b of the frame 122. The holding portion 52 is disposed along the central axis O. For this reason, deformation of the wiring 31 and the pipe 32 when the wiring 31 and the pipe 32 drawn into the second arm 12 from the distal end opening 142 are held by the holding portion 52 can be suppressed, and stress applied to the wiring 31 and the pipe 32 can be reduced. In particular, as illustrated in FIG. 12, the holding portion 52 overlaps the distal end opening 142 in plan view of the distal end opening 142, that is, in plan view from a direction along the central axis O. For this reason, deformation of the wiring 31 and the pipe 32 when the wiring 31 and the pipe 32 drawn into the second arm 12 from the distal end opening 142 are held by the holding portion 52 can be more effectively suppressed, and stress applied to the wiring 31 and the pipe 32 can be more effectively reduced.

As illustrated in FIGS. 3, 4, and 8, at least one of the wiring 31 and the pipe 32 held by the wiring holding member 5 as described above is drawn to the distal end side of the motors 231 and 241 through the gap G between the motors 231 and 241. Specific wiring 31 and a specific pipe 32 are coupled to each of the connectors included in the connector group 161, and specific wiring 31 is coupled to the brake control substrate 8. As described above, by drawing the wiring 31 and the pipe 32 to the distal end side of the motors 231 and 241 via the gap G between the motors 231 and 241, it is not necessary to secure a space for drawing the wiring 31 and the pipe 32 above the motors 231 and 241 as in the related art. Therefore, reduction in height of the second arm 12 and reduction in size and weight of the second arm 12 caused by the reduction in height can be achieved.

In particular, as illustrated in FIG. 8, the distal end opening 142 and the holding portion 52 are positioned below uppermost ends of the motors 231 and 241, that is, the upper end of the motor 231 in the present embodiment. For this reason, installation locations of the coupling portion 124 and the wiring holding member 5 can be kept low, and the second arm 12 can be further reduced in height. In addition, the wiring 31 and the pipe 32 can pass through the gap G between the motors 231 and 241 in a natural shape, and stress applied to the wiring 31 and the pipe 32 can be more effectively reduced. In addition, the total length of the wiring 31 and the pipe 32 can also be shortened.

In addition, as illustrated in FIG. 8, the gap G, the holding portion 52, and the distal end opening 142 overlap each other in plan view from the direction along the imaginary central axis A, that is, the holding portion 52 and the distal end opening 142 are positioned between the motors 231 and 241. In other words, the gap G, the holding portion 52, and the distal end opening 142 are disposed side by side along the imaginary central axis A. For this reason, the wiring 31 and the pipe 32 drawn into the second arm 12 from the distal end opening 142 can be smoothly guided to the gap G in the same flow. Therefore, stress applied to the wiring 31 and the pipe 32 can be more effectively reduced. In addition, the total length of the wiring 31 and the pipe 32 can also be shortened. In particular, in the present embodiment, a width W2 of the holding portion 52 is smaller than a width W1 of the gap G, which is a distance between the motors 231 and 241, in plan view from the direction along the imaginary central axis A. That is, W1>W2 is satisfied. With such a relationship, the wiring 31 and the pipe 32 are less likely to spread by the width W1 or more in a portion held by the holding portion 52, and thus the wiring 31 and the pipe 32 can be smoothly guided to the gap G.

In addition, as illustrated in FIGS. 3 and 4, the duct 14 is disposed such that the distal end opening 142 is inclined to face the distal end side of the second arm 12. That is, the central axis O of the duct 14 is inclined to the distal end side. For this reason, the wiring 31 and the pipe 32 drawn into the second arm 12 from the distal end opening 142 can be smoothly guided to the gap G in the same flow. Therefore, stress applied to the wiring 31 and the pipe 32 can be more effectively reduced. In addition, the total length of the wiring 31 and the pipe 32 can also be shortened.

The robot system 100 is described hereinbefore. The robot 1 included in such a robot system 100 has, as described above, the base 10, the first arm 11 that is joined to the base 10 and that rotates around the first rotation axis J1 with respect to the base 10, the second arm 12 that is joined to the first arm 11 at the proximal end portion thereof and that rotates around the second rotation axis J2, which is parallel to the first rotation axis J1, with respect to the first arm 11, the spline shaft 133 that is disposed at the distal end portion of the second arm 12 and that linearly moves along the third rotation axis J3, which is parallel to the first rotation axis J1, with respect to the second arm 12 and that rotates around the third rotation axis J3, the motor 241 that is the first motor which is disposed in the second arm 12 and which linearly moves the spline shaft 133 along the third rotation axis J3 with respect to the second arm 12, the motor 231 that is the second motor which is disposed in the second arm 12 and which at least rotates the spline shaft 133 around the third rotation axis J3 with respect to the second arm 12, the duct 14 that couples the base 10 and the second arm 12 and that has the proximal end opening 141 facing the inside of the base 10 and the distal end opening 142 facing the inside of the second arm 12, the wiring 31 that is drawn into the second arm 12 from the inside of the base 10 through the inside of the duct 14, and the wiring holding member 5 that is disposed in the second arm 12 and that includes the holding portion 52 which holds the wiring 31 drawn into the second arm 12 from the duct 14. In addition, the second arm 12 includes the arm base 121 that is joined to the first arm 11 and that holds the motor 231 and the motor 241 and the frame 122 that is fixed to the arm base 121 and that includes the coupling portion 124 to which the duct 14 is coupled. In addition, when the line segment that is orthogonal to the second rotation axis J2 and that passes through the second rotation axis J2 and the third rotation axis J3 is defined as the imaginary central axis A of the second arm 12, the motor 231 and the motor 241 are arranged in parallel along the direction H intersecting the imaginary central axis A in plan view from the direction along the second rotation axis J2, the distal end opening 142 of the duct 14 is positioned closer to the proximal end side of the second arm 12 than the motor 231 and the motor 241 are, the holding portion 52 is positioned between the motor 231 and the motor 241 in plan view from the direction along the imaginary central axis A, and the wiring 31 is drawn to the distal end side of the second arm 12 through the gap G between the motor 231 and the motor 241. With such a configuration, it is not necessary to secure a space for drawing the wiring 31 above the motors 231 and 241 as in the related art. Therefore, the second arm 12 can be reduced in height.

In addition, as described above, in plan view from the direction along the imaginary central axis A, each of the holding portion 52 and the distal end opening 142 is positioned between the motor 231 and the motor 241. For this reason, the wiring 31 drawn into the second arm 12 from the distal end opening 142 can be smoothly guided to the gap G in the same flow. Therefore, stress applied to the wiring 31 can be more effectively reduced. In addition, the total length of the wiring 31 can also be shortened.

In addition, as described above, the duct 14 is disposed such that the distal end opening 142 faces the distal end side of the second arm 12. For this reason, the wiring 31 drawn into the second arm 12 from the distal end opening 142 can be smoothly guided to the gap G in the same flow. Therefore, stress applied to the wiring 31 can be more effectively reduced. In addition, the total length of the wiring 31 can also be shortened.

In addition, as described above, the holding portion 52 is disposed along the central axis O of the duct 14. For this reason, deformation of the wiring 31 when the wiring 31 drawn into the second arm 12 from the distal end opening 142 is held by the holding portion 52 can be suppressed, and stress applied to the wiring 31 can be reduced.

In addition, as described above, the distal end opening 142 and the holding portion 52 overlap each other in plan view from the direction along the central axis O of the duct 14. For this reason, deformation of the wiring 31 when the wiring 31 drawn into the second arm 12 from the distal end opening 142 is held by the holding portion 52 can be more effectively suppressed, and stress applied to the wiring 31 can be more effectively reduced.

In addition, as described above, the wiring holding member 5 is fixed to the frame 122. For this reason, the holding portion 52 is easily disposed close to the distal end opening 142, and the wiring 31 is easily held.

In addition, as described above, the first rotation axis J1 follows the vertical direction, the holding portion 52 and the distal end opening 142 are positioned below a higher one of the upper end of the motor 241 and the upper end of the motor 231, each of the holding portion 52 and the distal end opening 142 is positioned between the motor 231 and the motor 241 in plan view from the direction along the imaginary central axis A, the duct 14 is disposed such that the distal end opening 142 faces the distal end side of the second arm 12, the wiring holding member 5 is fixed to the frame 122, and the holding portion 52 is disposed along the central axis O of the duct 14, overlaps the distal end opening 142 in plan view from the direction along the central axis O of the duct 14, and further has a width smaller than the gap G, which is the distance between the motor 231 and the motor 241, in plan view from the direction along the imaginary central axis A. For this reason, deformation of the wiring 31 when the wiring 31 drawn into the second arm 12 from the distal end opening 142 is held by the holding portion 52 can be suppressed, and stress applied to the wiring 31 can be reduced.

In addition, as described above, the robot system 100 has the robot 1 and the control device 9 that controls driving of the robot 1. The robot 1 has the base 10, the first arm 11 that is joined to the base 10 and that rotates around the first rotation axis J1 with respect to the base 10, the second arm 12 that is joined to the first arm 11 at the proximal end portion thereof and that rotates around the second rotation axis J2, which is parallel to the first rotation axis J1, with respect to the first arm 11, the spline shaft 133 that is disposed at the distal end portion of the second arm 12 and that linearly moves along the third rotation axis J3, which is parallel to the first rotation axis J1, with respect to the second arm 12 and that rotates around the third rotation axis J3, the motor 241 that is the first motor which is disposed in the second arm 12 and which linearly moves the spline shaft 133 along the third rotation axis J3 with respect to the second arm 12, the motor 231 that is the second motor which is disposed in the second arm 12 and which rotates the spline shaft 133 around the third rotation axis J3 with respect to the second arm 12, the duct 14 that couples the base 10 and the second arm 12 and that has the proximal end opening 141 facing the inside of the base 10 and the distal end opening 142 facing the inside of the second arm 12, the wiring 31 that is drawn into the second arm 12 from the inside of the base 10 through the inside of the duct 14, and the wiring holding member 5 that is disposed in the second arm 12 and that includes the holding portion 52 which holds the wiring 31 drawn into the second arm 12 from the duct 14. In addition, the second arm 12 includes the arm base 121 that is joined to the first arm 11 and that holds the motor 231 and the motor 241 and the frame 122 that is fixed to the arm base 121 and that includes the coupling portion 124 to which the duct 14 is coupled. In addition, when the line segment that is orthogonal to the second rotation axis J2 and that passes through the second rotation axis J2 and the third rotation axis J3 is defined as the imaginary central axis A of the second arm 12, the motor 231 and the motor 241 are arranged in parallel along the direction H intersecting the imaginary central axis A in plan view from the direction along the second rotation axis J2, the distal end opening 142 of the duct 14 is positioned closer to the proximal end side of the second arm 12 than the motor 231 and the motor 241 are, the holding portion 52 is positioned between the motor 231 and the motor 241 in plan view from the direction along the imaginary central axis A, and the wiring 31 is drawn to the distal end side of the second arm 12 through the gap G between the motor 231 and the motor 241. With such a configuration, it is not necessary to secure a space for drawing the wiring 31 above the motors 231 and 241 as in the related art. Therefore, the second arm 12 can be reduced in height.

The robot and the robot system of the present disclosure are described hereinbefore based on the illustrated embodiment. However, the present disclosure is not limited thereto, and the configuration of each portion can be replaced with any configuration having the same function. In addition, any other configurations may be added to the present disclosure.

In addition, the wiring holding member 5 holds the wiring 31 and the pipe 32 to be hung from above in the embodiment described above, but without being limited thereto, for example, as illustrated in FIG. 13, may be held to be supported from below. In addition, the robot 1 is a floor-standing type SCARA robot in which the base 10 is fixed to the floor or the like in the embodiment described above, but may be a ceiling-hanging type SCARA robot in which the base 10 is hung from a ceiling. In this case, the base 10 is hung from, for example, a top plate positioned above a frame-shaped leg portion of a stand.

1. A robot comprising:
a base;
a first arm that is joined to the base and that rotates around a first rotation axis with respect to the base;
a second arm that is joined to the first arm at a proximal end portion and that rotates around a second rotation axis, which is parallel to the first rotation axis, with respect to the first arm;
a shaft that is disposed at a distal end portion of the second arm, that linearly moves along a third rotation axis, which is parallel to the first rotation axis, with respect to the second arm, and that rotates around the third rotation axis;
a first motor that is disposed in the second arm and that linearly moves the shaft along the third rotation axis with respect to the second arm;
a second motor that is disposed in the second arm and that rotates the shaft around the third rotation axis with respect to the second arm;
a duct that couples the base and the second arm and that includes a proximal end opening which faces an inside of the base and a distal end opening which faces an inside of the second arm;
wiring that is drawn into the second arm from the inside of the base through an inside of the duct; and
a wiring holding member that is disposed in the second arm and that includes a holding portion which holds the wiring drawn into the second arm from the duct, wherein
the second arm includes an arm base that is joined to the first arm and that holds the first motor and the second motor and a frame that is fixed to the arm base and that includes a coupling portion to which the duct is coupled, and
when a line segment that is orthogonal to the second rotation axis and that passes through the second rotation axis and the third rotation axis is defined as an imaginary central axis of the second arm,
the first motor and the second motor are arranged in parallel along a direction intersecting the imaginary central axis in plan view from a direction along the second rotation axis,
the distal end opening of the duct is positioned closer to a proximal end side of the second arm than the first motor and the second motor are,
in plan view from a direction along the imaginary central axis, the holding portion is positioned between the first motor and the second motor, and
the wiring passes between the first motor and the second motor and is drawn to a distal end side of the second arm.

2. The robot according to claim 1, wherein
in plan view from the direction along the imaginary central axis, each of the holding portion and the distal end opening is positioned between the first motor and the second motor.

3. The robot according to claim 1, wherein
the duct is disposed such that the distal end opening faces the distal end side of the second arm.

4. The robot according to claim 1, wherein
the holding portion is disposed along a central axis of the duct.

5. The robot according to claim 1, wherein
in plan view from a direction along a central axis of the duct, the distal end opening and the holding portion overlap each other.

6. The robot according to claim 1, wherein
the wiring holding member is fixed to the frame.

7. The robot according to claim 1, wherein
the first rotation axis follows a vertical direction,
the holding portion and the distal end opening are positioned below a higher one of an upper end of the first motor and an upper end of the second motor,
in plan view from the direction along the imaginary central axis, each of the holding portion and the distal end opening is positioned between the first motor and the second motor,
the duct is disposed such that the distal end opening faces the distal end side of the second arm,
the wiring holding member is fixed to the frame, and
the holding portion is disposed along a central axis of the duct, overlaps the distal end opening in plan view from a direction along the central axis of the duct, and further has a width smaller than a distance between the first motor and the second motor in plan view from the direction along the imaginary central axis.

8. A robot system comprising:
a robot; and
a control device that controls driving of the robot, wherein
the robot includes
a base,
a first arm that is joined to the base and that rotates around a first rotation axis with respect to the base,
a second arm that is joined to the first arm at a proximal end portion and that rotates around a second rotation axis, which is parallel to the first rotation axis, with respect to the first arm,
a shaft that is disposed at a distal end portion of the second arm, that linearly moves along a third rotation axis, which is parallel to the first rotation axis, with respect to the second arm, and that rotates around the third rotation axis,
a first motor that is disposed in the second arm and that linearly moves the shaft along the third rotation axis with respect to the second arm,
a second motor that is disposed in the second arm and that rotates the shaft around the third rotation axis with respect to the second arm,
a duct that couples the base and the second arm and that includes a proximal end opening which faces an inside of the base and a distal end opening which faces an inside of the second arm,
wiring that is drawn into the second arm from the inside of the base through an inside of the duct, and
a wiring holding member that is disposed in the second arm and that includes a holding portion which holds the wiring drawn into the second arm from the duct,
the second arm includes an arm base that is joined to the first arm and that holds the first motor and the second motor and a frame that is fixed to the arm base and that includes a coupling portion to which the duct is coupled, and
when a line segment that is orthogonal to the second rotation axis and that passes through the second rotation axis and the third rotation axis is defined as an imaginary central axis of the second arm,
the first motor and the second motor are arranged in parallel along a direction intersecting the imaginary central axis in plan view from a direction along the second rotation axis,
the distal end opening of the duct is positioned closer to a proximal end side of the second arm than the first motor and the second motor are,
in plan view from a direction along the imaginary central axis, the holding portion is positioned between the first motor and the second motor, and
the wiring passes between the first motor and the second motor and is drawn to a distal end side of the second arm.
